(19) United States
(12) Patent Application Publication
(10) Pub. No.: US 2017/0012847 A1
(43) Pub. Date: Jan. 12, 2017

(54) VISUALIZING RESOURCE RELATIONSHIPS USING KEY PEFORMANCE INDICATORS

(71) Applicant: Microsoft Technology Licensing, LLC, Redmond, WA (US)

(72) Inventors: Christian Liensberger, Bellevue, WA (US); James Eldon Tillinghast, Seattle, WA (US); Mark Wade Heninger, Preston, WA (US); Christina Storm, Seattle, WA (US); Chairy Chiu Ying Cheung, Redmond, WA (US); Amir Netz, Bellevue, WA (US)

(21) Appl. No.: 14/793,990

(22) Filed: Jul. 8, 2015

(51) Int. Cl. H04L 12/26

(52) U.S. Cl. CPC H04L 43/0876; H04L 43/12

(57) ABSTRACT

The resources of an organization may provide various functions and services, and the performance of the resources may be of interest. Performance indicators (e.g., network bandwidth, I/O throughput, and processing capacity) may be measured and logged, and examined in the event of diminished performance in order to identify a non-performing resource. However, because resources may depend on other resources, and to different degrees, the performance of the first resource may be limited by the performance of a related resource, and logging respective resource performance may not inform this determination. An embodiment of the techniques presented herein may evaluate an effect of the performance indicators of a first resource on the performance indicators of related resources (e.g., through historic comparisons or differential testing), and a visual resource map may include a visual indicator of the effect of performance indicators of a first resource on the performance indicators of a related resource.

### BACKGROUND

Within the field of computing, many scenarios involve a presentation of a set of resources of an organization, such as a resource manifest of servers that communicate over an organization network. The resource manifest of servers enables a user to review the number, arrangement, and composition of the resources, as well as details of each resource, such as a resource type and capacity. In order to evaluate and facilitate the functioning of the organization resources, the performance of the resources may be periodically evaluated, and a set of performance indicators that describe the performance of the resources may recorded in a resource performance log. If the set of resources begins to perform inadequately, an administrator may evaluate the resource performance log to identify a resource exhibiting poor performance indicators, to determine the extent and history of the diminished performance, to evaluate a cause of the loss of performance by the resource, and to assess the effectiveness of attempts to repair, replace, and/or supplement the underperforming resources. Additionally, while planning expansions of the capabilities of the set of resources of the organization, a user may examine the resource performance log to determine the resources that serve as a performance bottleneck, and to estimate the achievable gain in performance through various adjustments of the set of resources.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While an examination of a resource performance log may reveal some information that may assist with the assessment of the set of resources, some circumstances may be difficult to identify from per-resource performance indicators. In particular, a first resource that exhibits insufficient performance may be operating in cooperation with several other resources, such as a file server, a database server, and a network switch. The cause of the poor performance may not be the capabilities of the first resource, but rather the capabilities of one of the related resources. For example, a database server that is performing poorly may have ample processing capabilities, but may be rate-limited either by the I/O capabilities of a file server where the database is stored, by a process server from which the database receives queries, or by the bandwidth of a network switch. Moreover, each related resource may contribute to the performance of the database server in a different degree. For example, a network switch may exhibit reduced bandwidth, but this reduction may not actually impact the performance of the database server; however, a small performance reduction in the file server may result in a significant reduction of the performance of the database server. Accordingly, it may be difficult to determine why the performance of a resource is inadequate or reduced based on an examination of a resource performance log. For example, administrators may expend time and resources to restore the bandwidth of the network switch, only to discover that the performance of the network switch is not the cause of the reduced performance of the database server.

Presented herein are techniques for presenting resources to a user in a manner that includes an indication of the effects of the performance of various resources on related resources of the organization.

As a first embodiment of the techniques presented herein, a device may include a system that describes the resources of an organization, where the system comprises a performance evaluator that identifies a first performance indicator of a first resource of the organization, and a second performance indicator of a second resource of the organization, and determines an effect of the first performance indicator of the first resource on the second performance indictor of the second resource; and a visual resource map presenter that presents to the user, on the display, a visual resource map of the resources of the organization that includes a visual indicator of the effect of the first performance indicator of the first resource on the second performance indicator of the second resource.

A second embodiment of the techniques presented herein involves a method of presenting resources of an organization to a user of a device having a processor and a display where the method comprises executing, on the processor, instructions that cause the device to identify a first performance indicator of a first resource of the organization, and a second performance indicator of a second resource of the organization; determine an effect of the first performance indicator of the first resource on the second performance indictor of the second resource; and present to the user, on the display, a visual resource map of the resources of the organization that includes a visual indicator of the effect of the first performance indicator of the first resource on the second performance indicator of the second resource.

A third embodiment of the techniques presented herein involves a method of enabling a user to examine resources of an organization on a device having a processor and a display, where the method comprises executing, on the processor, instructions that cause the device to, responsive to a selection by the user of an adjustment of a performance indicator of a first resource of the organization, determine an effect of the adjustment of the first performance indicator of the first resource on a second performance indictor of a second resource of the organization; and present to the user, on the display, a visual resource map of the resources of the organization a visual indicator of the effect of the adjustment of the first performance indicator of the first resource on the second performance indicator of the second resource.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring a resource manifest of resources of an organization and a resource performance log of performance indicators for the respective resources.

FIG. 2 is an illustration of an example scenario featuring a performance of a resource of an organization that is dependent, to varying degrees, upon the performance of related resources of the organization.

FIG. 3 is an illustration of a determination of an effect of various related resources on a selected resource of an organization, and the presentation of a map of the resources of the organization that visually indicates the effects of the performance indicators of various resources on related resources, in accordance with the techniques presented herein.

FIG. 4 is an illustration of an example device featuring an example system for presenting resources of an organization to a user, in accordance with the techniques presented herein.

FIG. 5 is an illustration of an example method of presenting resources of an organization to a user, in accordance with the techniques presented herein.

FIG. 6 is an illustration of an example method of enabling a user to examine resources of an organization, in accordance with the techniques presented herein.

FIG. 7 is an illustration of an example memory device storing instructions that cause a device to present resources of an organization to a user, in accordance with the techniques presented herein.

FIG. 8 is an illustration of example scenarios featuring techniques for displaying a visual resource map of the resources of an institution over a time range and with heat maps that visually indicate resource usage, in accordance with the techniques presented herein.

FIG. 9 is an illustration of an example scenario featuring techniques for enabling a user to evaluate and simulate designs of a resource set of resources of an institution using a visual resource map, in accordance with the techniques presented herein.

FIG. 10 is an illustration of an example scenario featuring techniques for evaluating and recommending adjustments of a resource set of resources of an institution using a visual resource map, in accordance with the techniques presented herein.

FIG. 11 is an illustration of an example scenario featuring a computing environment within which the techniques presented herein may be implemented and/or utilized.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

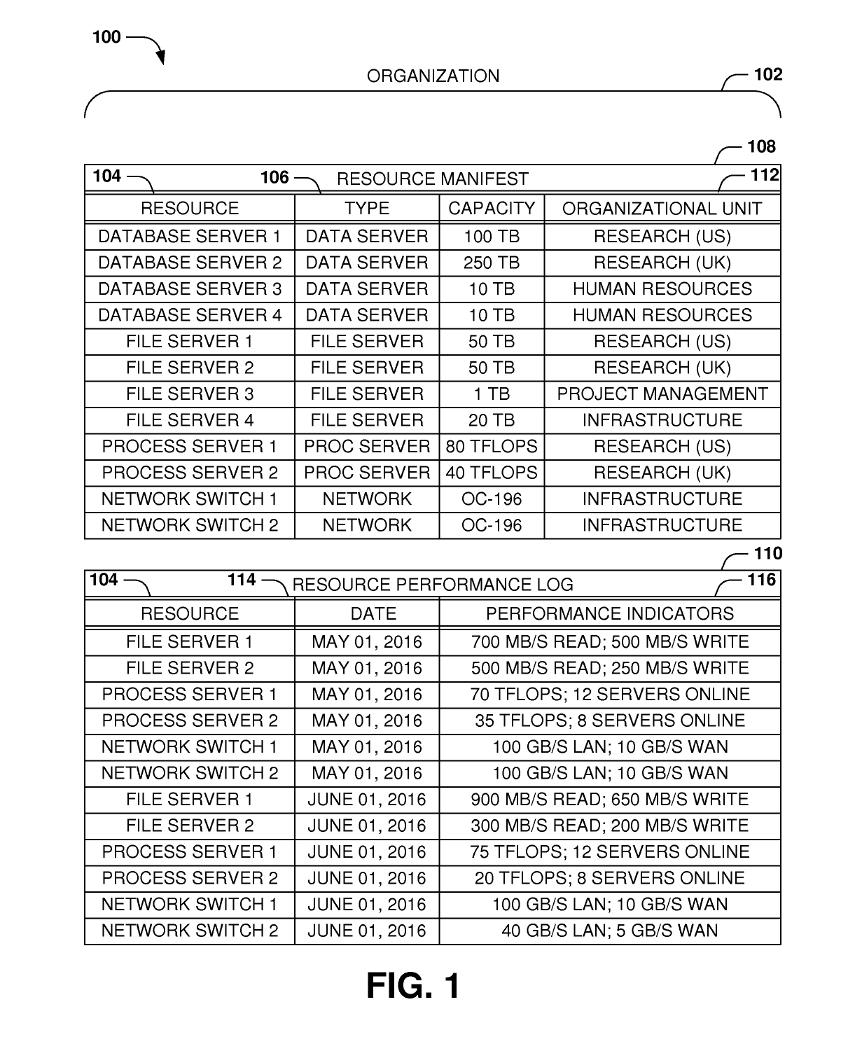

FIG. 1 is an illustration of an example scenario 100 featuring a set of resources 104 of an organization 102, and various tools that may be utilized to enumerate, document, and describe such resources 104. In this example scenario 100, the resources 104 comprise servers that have been allocated to various organizational units 112, such as divisions or departments of the organization 102 that provide different roles and functions for the organization 102. Respective resources 104 may vary according to name, resource type 106 (e.g., the equipment, role, services, and data provided by each server), and capacity (e.g., storage capacity, processing capacity, and network bandwidth).

A user of the organization 102, such as an information technology administrator, may prepare and maintain a resource manifest 108 as a record of the resources 104 of the organization 102. For example, the user may insert records in the resource manifest 108 when new resources 104 are acquired by the organization 102, and may update the resource manifest 108 when resources 104 are physically relocated, organizationally reassigned to different organization units 112, reconfigured with different equipment, and/or reallocated to store different types of data. The user may also utilize automated techniques to facilitate the preparation of a resource manifest 108, such as a network scanning or enterprise management tool that query each resource 104 of the organization 102, and record the details reported by the resource 104.

Additionally, a resource performance log 110 may be generated as a record of the performance of the resources 104 of the organization 102. The resource performance log 110 may comprise a set of performance indicators 116 for the respective resources 104, which may be measured periodically (e.g., once a week or once a month), and which may reflect the properties of various capabilities and operations of the resources 104. For example, the performance indicators 116 of a file server may include the read rate and the write rate; the performance indicators 116 of a process server cluster may include a total cluster performance as measured in teraflops, and the number of servers available in the cluster; and the performance indicators 116 of a network switch may include an achievable throughput for data transfers within the local area network (LAN) and across a wide area network (WAN) such as the internet.

The performance indicators 116 may be recorded in order to inform various forms of analysis of the performance of the resources 104 of the organization 102. As a first such example, the performance indicators 116 may be measured and evaluated to detect the malfunctioning of a resource 104; e.g., a significant loss of read or write speed in a file server may indicate a malfunctioning storage device of a storage array that is due to be replaced. As a second such example, a detected loss of performance within the resources 104 of the organization 102 may be investigated by examining the performance indicators 116 of various resources 104 in order to identify a particular resource 104 that is exhibiting poor performance. For example, users may report slow network access, and repairs may begin by identifying a network switch within the set of resources 104 that reports poor performance indicators 116. Moreover, during or after completing repairs to a poorly performing resource 104, the user may reevaluate the performance indicators 116 of the resource 104 to verify a restoration of the performance of the resource 104. As a third such example, a user may wish to expand the performance of the resources 104 of the organization 102, such as increasing storage space, increasing computational capacity, reducing I/O latency, and/or increasing local area network or wide area network bandwidth, and may examine the resource performance log 110 to determine opportunities for reconfiguring, reorganizing, supplementing, and/or replacing resources 104 with a predicted expansion of the performance of the resources 104. The resource performance log 110 and/or resource manifest 108 may therefore inform various forms of evaluation of the resources 104 of the organization 102.

However, some circumstances involving the resources 104 of the organization 102 may not be adequately informed by examining individual entries of a resource performance log 110 to evaluate the performance indicators 116 of individual resources 104. In some scenarios, the performance of a resource 104 of the organization 102 may be significantly determined or limited by the performance of a related resource 104 of the organization 102. Moreover, a first resource 104 may interoperate with several other resources 104 that affect the performance of the first resource 104 in varying degrees, which may complicate a determination of which resource 104 is responsible for a loss of performance of a particular resource 104 of the organization 102.

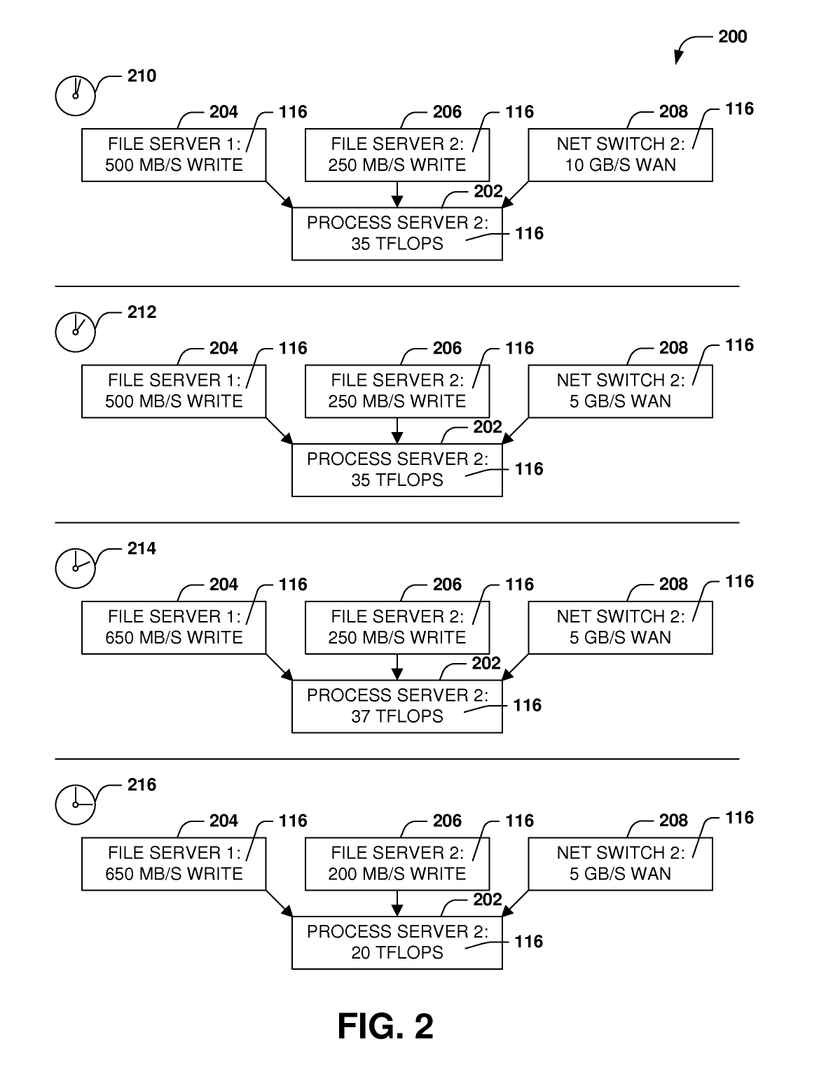

FIG. 2 presents an illustration of an example scenario 200 featuring a process server 202 that provides a service through interaction with a first file server 204, a second file server 206, and a network switch 208. In this example scenario 200, at a first time 210, the process server 202 may exhibit a performance indicator 116 indicating an acceptable throughput, and performance indicators 116 may also be measured and recorded for the first file server 204, the second file server 206, an the network switch 208.

At a second time 212, the performance of the network switch 208 may diminish (e.g., due to a loss of a router or downstream capacity), as indicated by the performance indicator 116 of the network switch 208. However, the performance of the process server 202 may not be significantly dependent upon the network switch 208 (e.g., the service provided by the process server 202 may involve intensive computation over comparatively small data sets), and/or the network switch 208 may have possessed an abundance of spare and unused capacity (possibly as reliability in case of an equipment failure), such that even a significant reduction of the performance indicator 116 of the network switch 208 may not impact the process server 202 or any other resources 104.

At a third time 214, the performance indicator 116 of the first file server 204 may increase, e.g., due to an equipment upgrade such as faster storage devices, or a reconfiguration of the file server 204 that reduces an inefficiency in the write process. The process server 202 may exhibit a modest increase in performance, as indicated by a marginal increase of the performance indicator 116 of the process server 202.

At a fourth time 214, the performance indicator of the second file server 206 may be marginally reduced, e.g., due to a failure of a storage device, or a reallocation of resources to complete a backup process. However, the performance indicators 116 of the process server 202 may be significantly reduced; e.g., the process server 116 may be highly dependent upon the performance of the second file server 206, such that even a modest loss of performance of the second file server 206 may cause a cascading backup of wait states within the process server 202 that cause a major loss of performance.

Notably, in the example scenario 200 of FIG. 2, the related resources 104 have varying degrees of effect on the performance indicator 116 of the process server 202. However, in order to determine the cause of the loss of performance, a user may incorrectly focus on the individual performance indicators 116, may conclude that a problem has arisen with the process server 202, and may expend time and effort to repair the process server 202 without productive results. The user may not notice the corresponding marginal loss of the performance indicator 116 of the second file server 206; may conclude that the correspondence of such events is coincidental, or even reversed (e.g., concluding that the second file server 206 exhibits reduced performance because of a problem with the process server); may not believe that a marginal reduction in the performance indicator 116 of the second file server 206 is responsible for the major loss of performance of the process server 202; and/or may instead focus on the significantly reduced performance of the network switch 208. Accordingly, the source of the reduced performance indicator 116 of the process server 202, i.e., the reduced performance of the second file server 206, may prove elusive and may frustrate the efforts of the user to alleviate the performance problem. Such complications may arise in unexpected ways; e.g., expanding the performance and throughput of a first resource 104 may overload the capacity of a second resource 104, and may actually reduce the performance indicators 116 of the second resource 104.

### B. Presented Techniques

The techniques presented herein involve the evaluation of relationships between and among the resources 104 of an organization 102 to determine which performance indicators 116 of respective resources 104 have an effect on the performance indicators 116 of related resources 104. Such an effect may be automatically identified, modeled, and used for various forms of evaluation, such as alleviating a performance issue arising among the resources 104 of the organization 102; evaluating and reconfiguring the resources 104 of the organization 102; and/or projecting the effects of various upgrades of the resources 104 in furtherance of higher performance.

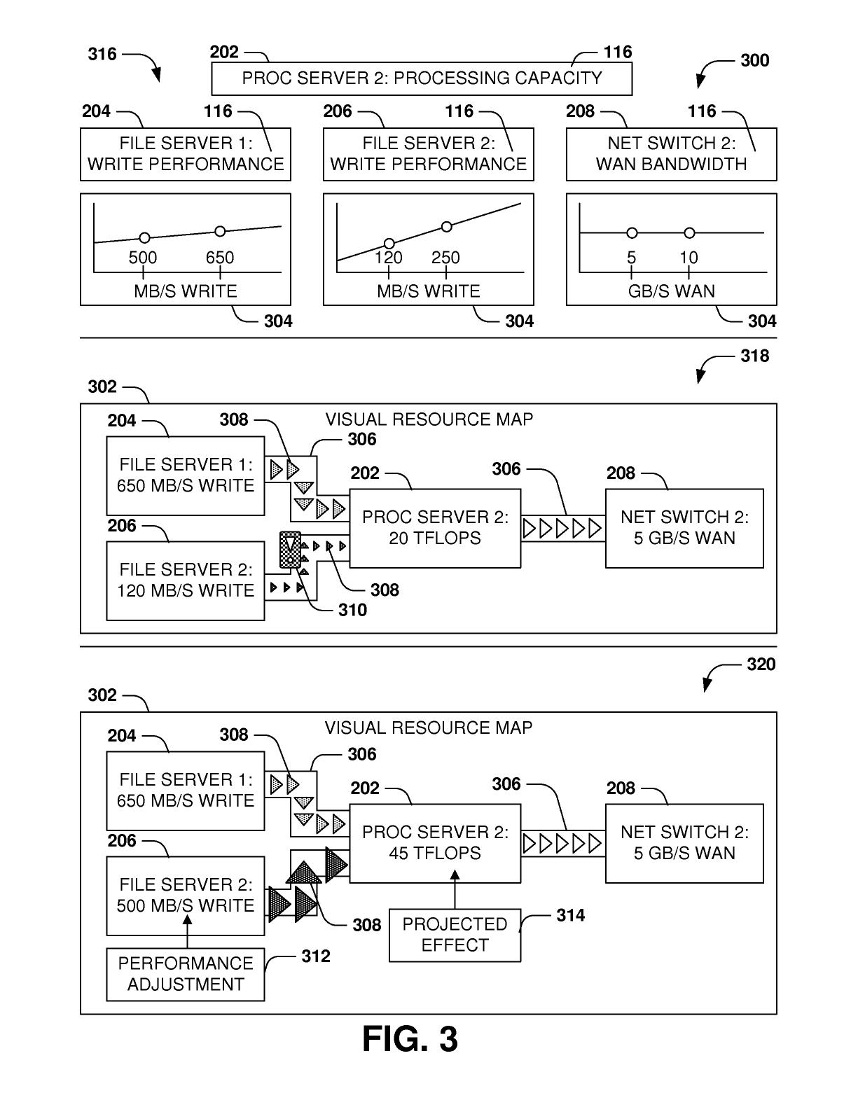

FIG. 3 is an illustration of an example scenario 300 featuring an application of the techniques presented herein, resulting in a visual resource map 302 indicating the performance of various resources 104 of the organization. In this example scenario 300, for the second process server 202, an analysis 316 is performed by comparing a performance indicator 116 of the resource 104 as the performance indicators 116 of other resources 116 vary, such as illustrated in the example scenario 200 of FIG. 2. The analysis 316 may be extrapolated from the correlation of various performance indicators 116 to generate a model of the effect 304 of each related resource 104 on a selected resource 104. While the analysis 316 in the example scenario 300 of FIG. 3 depicts each effect 304 as a linear relationship, it may be appreciated that such an analysis 316 may reveal nonlinear relationships in the correlated performance of the resources 104.

In the analysis 316 of the example scenario 300 of FIG. 3, as the first file server 204 exhibits variance in write performance, the processing capacity performance indicator 116 of the second process server 202 gradually varies, demonstrating that the performance of the first file server 204 has a positive but minor effect 304 on the performance of the second process server 202. However, as the write performance indicator 116 of the second file server 206 changes, the write performance indicator 116 of the second process server 202 may vary by a larger magnitude, even exceeding the magnitude in the variance of the write performance indicator 116 of the second file server 206, thus demonstrating that the performance of the second file server 206 has a major effect 304 on the performance of the second process server 202. By contrast, the performance of the second network switch 208 is determined to have an inconsequential effect 304 on the performance of the second process server 202.

The analysis 316 may inform the generation and presentation of visual resource maps 302 of the resources 104 of the organization 102 that facilitate various forms of evaluation of the resources 104 by the user 102.

As a first such example 318, a first visual resource map 302 may be presented to indicate the effects 304 of various resources 104 on a selected resources 104, such as the second process server 202. The effects 304 may be illustrated as a visual connection 306 between the resources 104, with visual indicators 308 depicting the direction of the effect 304 (which, in some circumstances, may indicate a bidirectional effect); the magnitude of the effect 304, illustrated in this example scenario 300 as a shading of the visual indicator 308 to indicate that the performance of the first resource 104 significantly affects the performance of the second resource 104, and an absence of shading to indicate that the performances of the resources 104 are not significantly related by effect 304; and a sufficiency of the effect 304, illustrated in this example scenario 300 as an average size to indicate that the performance of the second resource 104 is acceptable (i.e., not unduly constrained) due to the performance of the first resource 104, and a small size to indicate that the performance of the second resource 104 is significantly constrained by the performance of the first resource 104. Additionally, it may be determined whether the constraint is currently of significant concern. For example, a reduced performance of the second file server 206 may significantly constrain the performance of the second process server 202, but the second process server 202 may not currently be in use, or may be used in ways that are not significantly affected by reduced performance. Alternatively, if the reduced performance of the second process server 202 has a significant impact on current uses of the second process server 202, an alert 310 may be displayed on the visual resource map 302 to draw the attention of a user to the effect 304 and the constraint on the performance of the second process server 202.

As a second such example 320, a second visual resource map 302 may be presented to assist a cost/benefit analysis of various adjustments of the resources 104 of the organization 102. For example, a user may consider investing in hardware upgrades to promote the performance of the second file server 206, such as adding a faster I/O interface or providing storage devices with faster read/write capacity. The user may specify a performance adjustment 312 that may be applied to the second file server 206, and the analysis 316 of the effects 304 of the resources may be applied to determine a projected effect 314 of the performance adjustment 312 that may affect the performance indicators 116 of the second file server 206 on the performance indicators 116 of the second process server 202. The effect 304 may be illustrated in the visual resource map 302 through the visual indicators 308; e.g., if the projected effect 314 is determined to be significantly large, the sizes of the visual indicators 308 may be increased, but if the projected effect 314 is deemed to be minor or inconsequential, the visual indicators 308 may remain of an average size. In this manner, visual resource maps 302 may be generated and presented that reflect the results of the analysis 316 of the performance relationships of the resources 104 and the effects 304 of the performance indicators 116 of a first resource 104 on the performance indicators 116 of a second resource 116 in accordance with the techniques presented herein.

### C. Technical Effects

Various uses of the techniques presented herein to present a set of resources 104 using a visual resource map 302 indicating the effects 304 of the performance of related resource 104 may result in a variety of technical effects.

As a first technical effect that may arise from the techniques presented herein, the analysis 316 of the effects 304 of performance of related resources 104 may assist a user in understanding the relationships of the resources 104. For example, a user may not even be aware that a first resource 104 is reliant upon a second resource (e.g., it may not have been clear that a database server was storing a database on a separate file server), but the automated generation and presentation of a visual resource map 302 may present a clear visual indicator to the user of the relationship of the resources 104.

As a second technical effect that may arise from the techniques presented herein, a user may seek to design a computational process for addition to the set of resources 104, and where the performance of the computational process is contingent upon a careful selection of the design in view of the performance dependencies of the resources 104. For example, if a database server has access to a file server where an index or cache may be stored, a developer may choose between designing the database server to rely upon the performance of the file server (because fluctuation of the performance indicators 116 of the file server does not have a significant effect on the database server), or forgoing such reliance (if the performance indicators 116 of the file server may have a deleterious effect 304 on the performance indicators 116 of the database server).

As a third technical effect that may arise from the techniques presented herein, a user may seek to identify a cause of a loss or limit of performance by the resources 104 of the organization 102, and may appreciate a view of the current relationships and performance of the set of resources 104. A visual resource map 302 may inform this type of analysis, and may enable the user to identify the causes of performance issues due to the effects 304 of performance on related resources 104.

As a fourth technical effect that may arise from the techniques presented herein, a user may seek to expand the capabilities of the resources 104 of the organization 102, and may wish to project the performance gain achieved from a performance adjustment 312 of a first resource 104. An analysis 316 of the effects 304 of adjustments of performance indicators 116 of a first resource 104 on the performance indicators 116 of other resources 104 may inform the user's evaluation of plans to adjust the resources 104 of the organization 102.

As a fifth technical effect that may arise from the techniques presented herein, the presentation of an interactive visual resource map 302 may enable a user to adjust the configuration of the resources of the institution, and the effects of such adjustments may be presented on the visual resource map 302. A device may also simulate variations in the resource set, and may display the results and effects of the performance of the resources. Moreover, the device may evaluate and score variants of the resources, including through automated generation of variants such as through a state search or genetic algorithm, and may present a recommendation to the user for enhancing the performance of the resource set based on the results of the evaluation. Many such technical effects may be achievable by various applications of the techniques presented herein.

### D. Example Embodiments

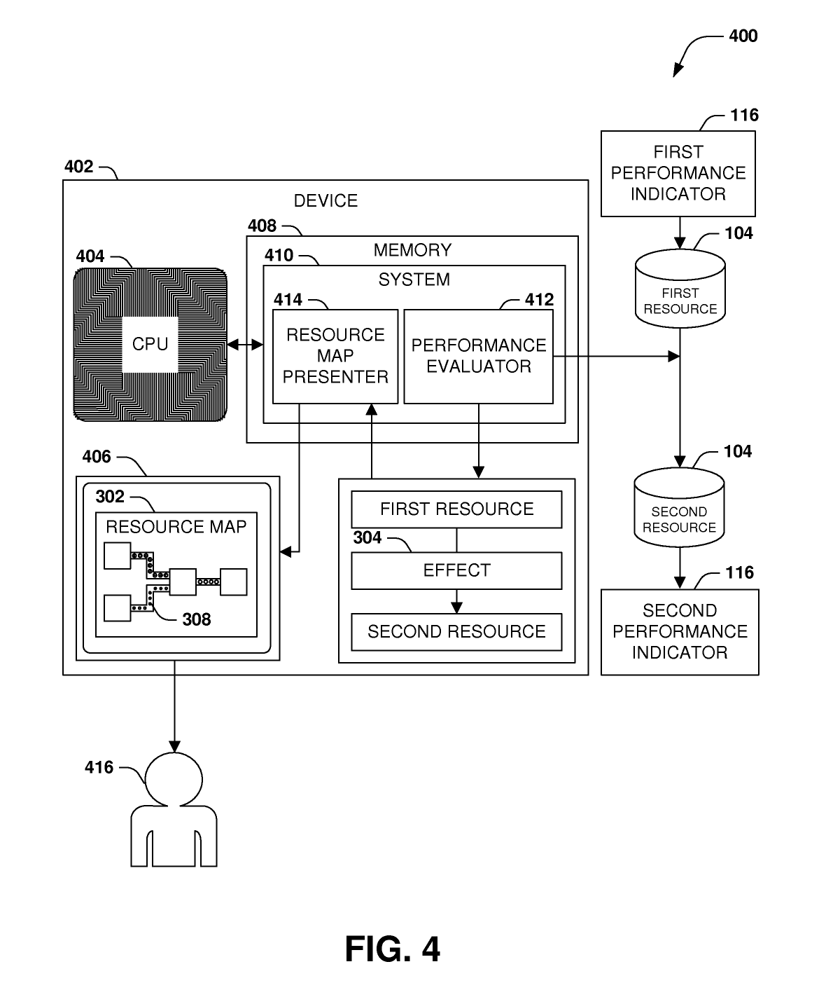

FIG. 4 presents a first example embodiment of the techniques presented herein, illustrated as an example device 402 featuring an example system 410 that causes the example device 402 to present a visual resource map 302 of the resources 104 of an organization 102 in accordance with the techniques presented herein.

In the example scenario 400 of FIG. 4, a device 402 having a processor 404, a display 406, and a memory 408 is utilized by a user 416 to examine the set of resources 104 of an organization 102. The device 402 may create in the memory 408 a system 410 of components that interoperate to achieve the presentation of such a visual resource map 302 on the display 406 in accordance with the techniques presented herein. The respective components of the system 410 may be implemented, e.g., as a set of instructions that, when executed on the processor 404, cause the device 402 to perform a portion of the techniques presented herein. The example system 410 comprises a performance evaluator 412, which identifies a first performance indicator 116 of a first resource 104 of the organization 102, and a second performance indicator 116 of a second resource 104 of the organization 102, and determines an effect 304 of the first performance indicator 116 of the first resource 104 on the second performance indictor 116 of the second resource 104. The example system 410 also comprises a visual resource map presenter 414 that presents to the user 416, on the display 406, a visual resource map 302 of the resources 104 of the organization 102 that includes a visual indicator 308 of the effect 304 of the first performance indicator 116 of the first resource 104 on the second performance indicator 116 of the second resource 104. In this manner, the example system 410 causes the example device 402 to generate and present the visual resource map 302 of the organization 102 to the user 416 with a visual indicator 308 of the effect 304 of the performance of a first resource 104 on a second resource 104, in accordance with the techniques presented herein.

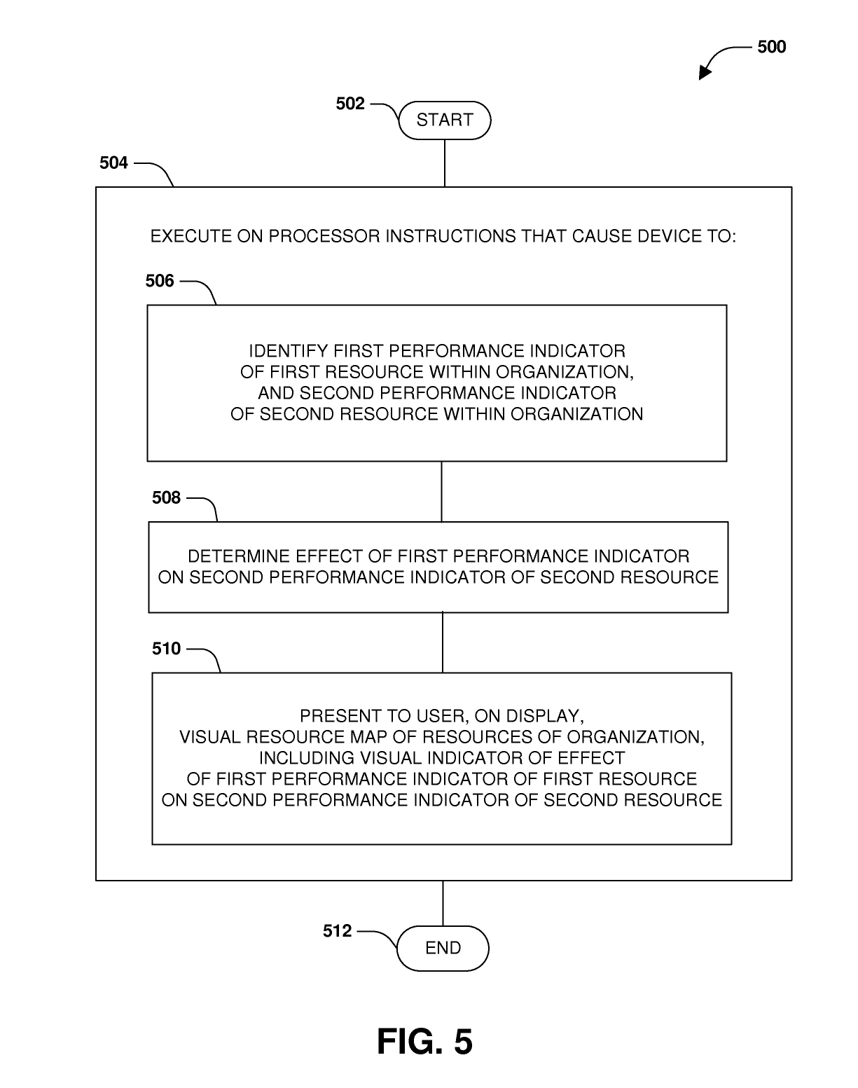

FIG. 5 presents a second example embodiment of the techniques presented herein, illustrated as an example method 500 of presenting, to a user 416 of a device having a processor and a display, a visual resource map 302 of the resources 104 of an organization 102. The example method 500 may be implemented, e.g., as a set of instructions stored in a memory component of a device, such as a memory circuit, a platter of a hard disk drive, a solid-state storage device, or a magnetic or optical disc, and organized such that, when executed on a processor of the device, cause the device to operate according to the techniques presented herein.

The example method 500 begins at 502 and involves executing 504 the instructions on a processor of the device. Specifically, executing 504 the instructions on the processor causes the device to identify 506 a first performance indicator 116 of a first resource 104 of the organization 102, and a second performance indicator 116 of a second resource 104 of the organization 102. Executing the instructions further causes the device to determine 508 an effect 304 of the first performance indicator 116 of the first resource 104 on the second performance indictor 116 of the second resource 104. Executing the instructions further causes the device to present 510 to the user 416, on the display 406, a visual resource map 302 of the resources 104 of the organization 102 that includes a visual indicator 308 of the effect 304 of the first performance indicator 116 of the first resource 104 on the second performance indicator 116 of the second resource 104. In this manner, the example method 500 enables the device to describe the resources 104 of the organization 102 and resources 104 to the user 416 through an automatically generated visual resource map 302 that indicates the performance relationships of the resources 104 in accordance with the techniques presented herein, and so ends at 512.

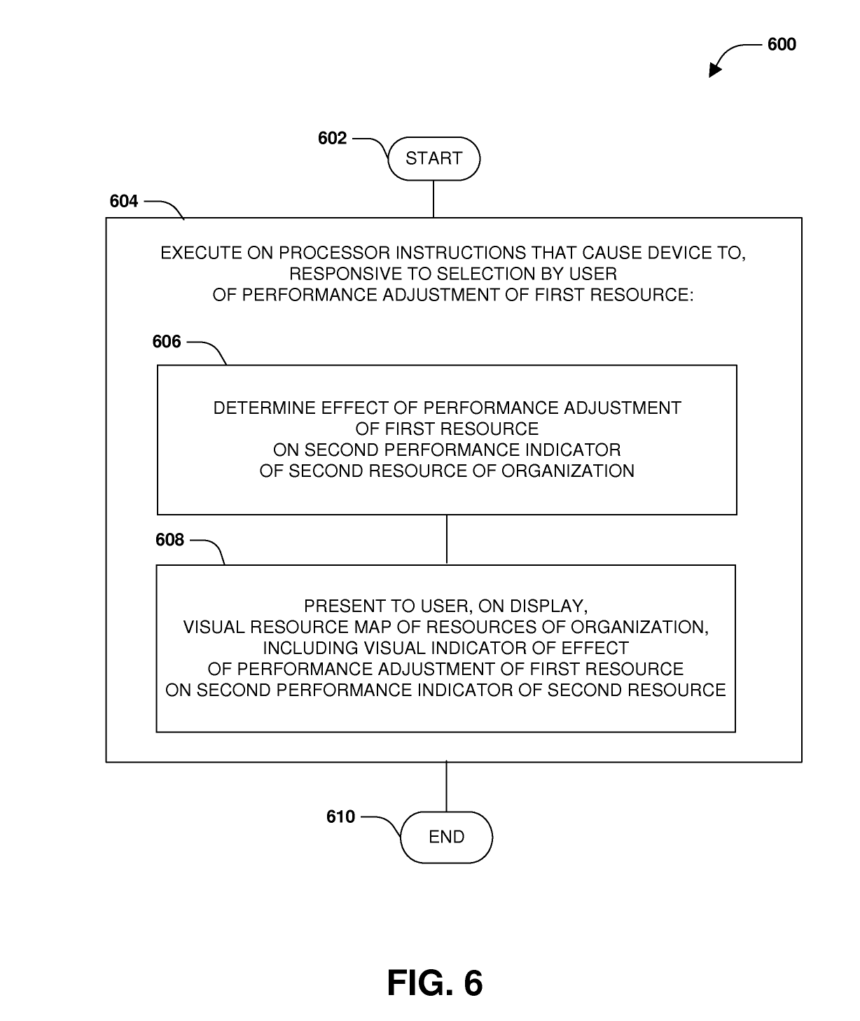

FIG. 6 presents a third example embodiment of the techniques presented herein, illustrated as an example method 600 of enabling a user 416 to examine with resources 104 of an organization 102. The example method 600 may be implemented, e.g., as a set of instructions stored in a memory component of a device, such as a memory circuit, a platter of a hard disk drive, a solid-state storage device, or a magnetic or optical disc, and organized such that, when executed on a processor of the device, cause the device to operate according to the techniques presented herein.

The example method 600 begins at 602 and involves executing 604 the instructions on a processor of the device, responsive to a selection by the user 416 of a performance adjustment 312 of a first resource 104 of the organization 102. Executing the instructions causes the device to determine 606 an effect 304 of the performance adjustment 312 of the first resource 104 on a second performance indictor 116 of a second resource 104 of the organization 102. Executing the instructions further causes the device to present 608 to the user 416, on the display 406, a visual resource map of the resources 104 of the organization 102, including a visual indicator 308 of the effect 304 of the performance adjustment 312 of the first resource 104 on the second performance indicator 116 of the second resource 104. In this manner, the example method 600 enables the device to present to the user 416 with a visual resource map 302 of the resources 104 of the institution 102 in accordance with the techniques presented herein, and so ends at 610.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

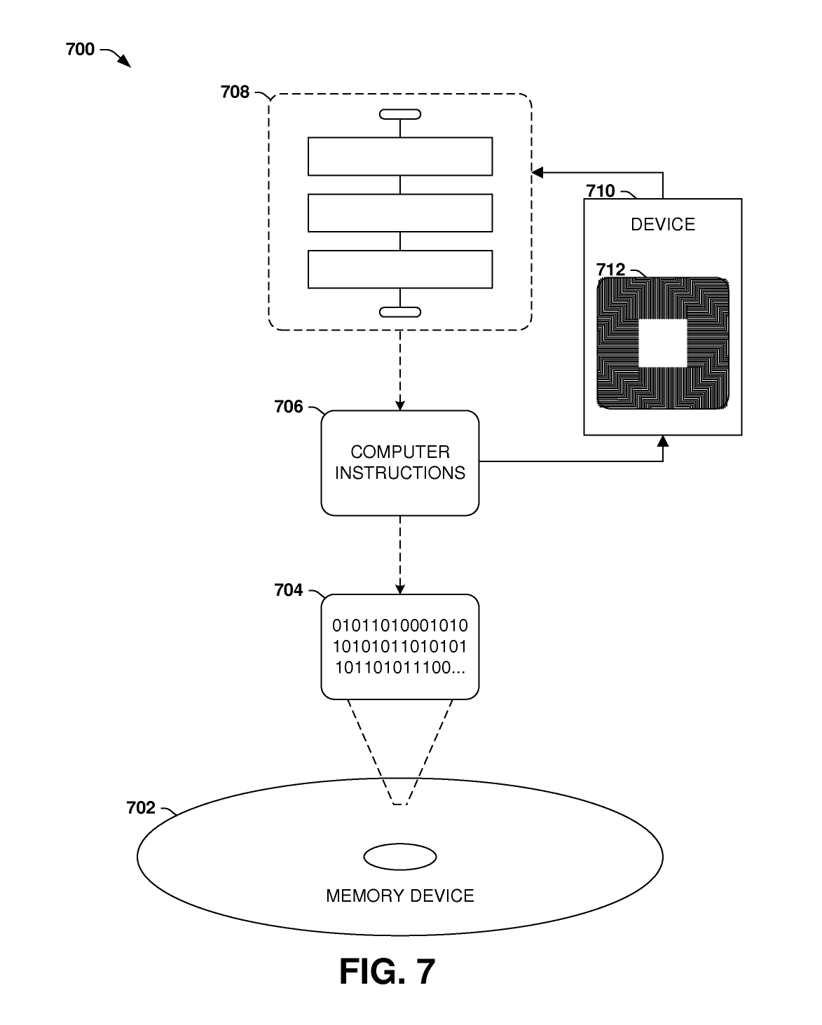

An example computer-readable medium that may be devised in these ways is illustrated in FIG. 7, wherein the implementation 700 comprises a memory device 702 (e.g., a CD-R, DVD-R, or a platter of a hard disk drive), on which is encoded computer-readable data 704. This computer-readable data 704 in turn comprises a set of computer instructions 706 that, when executed on a processor 708 of a device 710, cause the device 710 to operate according to the principles set forth herein.

In a first such embodiment, the processor-executable instructions 706 may create in a memory 408 of the device 402 a system for presenting a visual resource map 302 of the resources 104 of an organization 102 to a user 416 in accordance with the techniques presented herein, such as the example system 410 in the example scenario 400 of FIG. 4.

In a second system embodiment, the processor-executable instructions 706 may provide a method of presenting a visual resource map 302 of the resources 104 of an organization 102 to a user 416 in accordance with the techniques presented herein, such as the example method 500 of FIG. 5.

In a third such example, the processor-executable instructions 706 may cause a device to perform a method of enabling a user 416 to examine the resources 104 of an organization 102, such as the example method 600 of FIG. 6. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example system 410 of FIG. 4; the example method 500 of FIG. 5; the example method 600 of FIG. 6; and/or the example memory device 702 of FIG. 7) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized to achieve the configuration of a variety of devices and servers, such as workstations, laptops, tablets, mobile phones, game consoles, portable gaming devices, portable or non-portable media players, media display devices such as televisions, appliances, home automation devices, computing components integrated with a wearable device integrating such as eyewear or a watch, and supervisory control and data acquisition (SCADA) devices.

As a second variation of this first aspect, the techniques presented herein may be utilized to present a visual resource map 302 of resources 104 for many types of organizations 102, such as public and/or private companies; international, national, and/or local governments and/or regulatory bodies; non-profit institutions, such as schools and hospitals; social communities, such as the members of a township or a club; and social networks, such as friends and families.

As a third variation of this first aspect, the techniques presented herein may be utilized to present a visual resource map 302 of many types of resources 104 of the organization 102, such as databases and data sets; media items, such as recordings and/or libraries of text, audio, pictures, and/or video; content sources, such as web pages or websites; one or more processes or applications executing on a device; one or more physical devices, such as device peripherals sensors, and/or autonomous robots; and one or more real and/or virtual environments. Respective resources 104 presented in the visual resource map 302 may also be owned, managed, maintained, licensed by, secured by, and/or stored of the organization 102, and/or may be external to the organization 102 such as a publicly provided database or data set that is of interest to a particular organization 102.

As a fourth variation of this first aspect, the techniques presented herein may involve an evaluation of many types of performance and performance indicators 116 of the resources 104, such as read, write, and access speeds; capacity, such as processing capacity to execute additional instructions; throughput; bandwidth and latency; responsiveness, such as the responsive delay of a user interface; consistency, such as variance in completing operations; accuracy; wait times; and reliability. Many such scenarios may be devised wherein part or all of the techniques presented herein may be advantageously utilized.

E2. Determining Performance Effects of Resources

A second aspect that may vary among embodiments of the techniques presented herein involves the manner of determining the effect 304 of the performance of a first resource 104 on a second resource 104 of the organization.

As a first variation of this second aspect, many techniques may be used to measure a performance indicator 116 reflecting a performance of a resource 104. As a first such example, the organization 102 may utilize a variety of resources 104, and an embodiment of the techniques presented herein may be configured to enumerate and identify the resources 104, as well as the types of performance indicators 116 available for each resource 104, in order to perform an analysis 316 and generate a visual resource map 302. In particular, the respective resources 104 may be of a resource type selected from a resource type set, comprising a data resource that produces data; a content resource that provides content; a computational resource that performs computation; a storage resource that stores data; and a network resource that provides connectivity. It may be difficult to configure an embodiment to retrieve and evaluate performance indicators 116 from such a diverse range of resources 104. As one option, an embodiment may store, for respective resources types of the resource type set, a performance template that is applicable to resources 104 of the resource type to present performance indicators 116 for the resource 104. The embodiment may then evaluate the respective resources 104 of the organization 102 by identifying the performance indicators for respective resources by retrieving a selected performance template according to the resource type of the resource 104, and applying the selected performance template to the resource 104.

As a second example of this first variation of this second aspect, a resource 104 may report a model performance indicator reflecting the performance of the resource 104 in unconstrained conditions, such as a typical, anticipated, and/or theoretic performance indicators 116, e.g., a maximum theoretically achievable data rate. It may be undesirable to use the model performance indicator, as such use may not misinform the analysis 316 of the resource 104. Rather, an embodiment may determine a constraint of the resource 104 during the operation of the organization 102, and adjust the model performance indicator of the resource 104 according to the constraint to produce a practical performance indicator 116 of the resource 104. For example, a storage device may report a theoretically achievable read/write rate in unconstrained conditions, but when used within the organization 102, the storage device may typically be accessed over a network with a lower upload/download throughput bandwidth. The storage device may therefore be evaluated in the context of the analysis 316 according to the performance limit imposed by the network bandwidth constraint.

As a third example of this first variation of this second aspect, the performance indicators 116 of respective resources 104 may be measured, e.g., while the resource 104 is operating in an unconstrained context (such as operating in isolation or ideal conditions), an embodiment may initiate a load test of the resource 104, and, during the load test, measure the performance indicator 116 of the resource 104. Alternatively or additionally, while the resource 104 is operating in typical circumstances, such as the ordinary use of the resource 104 within the organization 102, an embodiment may record an observed performance indicator 116 of the resource 104, and identify the performance indicator of the resource 104 according to the observed performance indicator. It may be desirable to observe the performance indicators 116 of the resource 104 in a range of such conditions, and/or to measure a variety of performance indicators 116 (e.g., the seek rate, read rate, write rate, and latency of a storage device), in order to develop a high-accuracy and detailed model of the performance of the resource 104. For example, an embodiment may determine a condition of the operation of the resource 104 of the organization 102, wherein the condition affects the performance indicator 116 of the resource 104; record the observed performance indicator 116 and the condition of the operation; and develop a performance indicator model of the resource 104 over a range of the condition.

As a second variation of this second aspect, many techniques may be utilized to select a first resource 104 and a second resource 104 of the organization 102 that may have a performance relationship. As a first such example, for a particular first resource 104, a second resource 104 may be selected due to a determination that a result produced by the first resource 104 is consumed by the second resource 104 (e.g., the second resource 104 may await the completion of a process of the first resource 104; the second resource 104 may receive and consume data generated by the first resource 104; or the second resource 104 may receive and fulfill requests initiated by the first resource 104). As a second such example, for a particular first resource 104, a second resource 104 may be selected due to a determination that the first resource 104 and the second resource 104 share a limited capacity of a third resource, such as memory or a network connection. The sharing may be concurrent (e.g., two resources 104 that concurrently utilize a network connection, where the limited capacity comprises the bandwidth of the network connection may be shared between the resources 104), and/or in a mutually exclusive manner (e.g., a protected data structure may be regulated by a mutex or monitor, such that the second resource 104 is unable to utilize the data structure while it is in use by the first resource 104).

As a third variation of this second aspect, many techniques may be utilized to determine the effect 304 of the performance of a first resource 104 on the performance indicators 116 of the second resource 104.

As a first example of this third variation of this second aspect, the effect 304 of the first performance indicator 116 of the first resource 104 on the second performance indicator 116 of the second resource 104 may be determined through differential testing. For example, an initial observation of the second performance indicator 116 of the second resource 104 may be determined under an initial condition. While applying an adjustment to the first performance indicator 116 of the first resource 116, an adjusted observation of the second performance indicator 116 of the second resource 116 may be made, where the adjusted observation is deemed to be responsive to the adjustment of the first performance indicator 116. Comparing the initial observation to the adjusted observation of the second performance indicator 116 may reveal the effect 304 of the adjustment of the first performance indicator 116 on the second performance indicator 116 of the second resource 104. Such testing may be performed at various points over a range of adjustments of the first performance indicator 116 (e.g., interpolating the effect 304 between tested observations), and at different intervals or sampling rates, and may include positive and/or negative adjustments of the first performance indicator 116, as well as adjustments of combinations of the first performance indicator 116. Such testing may also reveal a linear or non-linear effect 304 of the first performance indicator 116 on the second performance indicator 116 of the second resource 104. Such testing may also be repeated (e.g., periodically) and/or performed in different operating conditions, and obtaining adjusted observations responsive to to a set of adjustments of the first performance indicator 116 may enable the development of an effect model of various adjustments of the first performance indicator 116 of the first resource 104 on the second performance indicator 116 of the second resource 104.

As a second example of this third variation of this second aspect, the effect 304 of the first performance indicator 116 on the second performance indicator 116 may be determined during ordinary usage of the resources 104. For example, an embodiment may record the first performance indicator 116 of the first resource 104 and the second performance indicator 116 of the second resourced 104 periodically over a time range, and may determine the effect 304 of the first resource indicator 116 on the second resource indicator 116 by correlating respective adjustments of the first performance indicator 116 of the first resource 104 with the second performance indicator 116 of the second resource 104. Many such techniques may be utilized to achieve an analysis 316 of the effect 304 of the first performance indicator 116 of the first resource 104 on the second performance indicator 116 of the second resource 104 in accordance with the techniques presented herein.

E3. Presenting Visual Resource Map

A third aspect that may vary among embodiments of the techniques presented herein involves the presentation of the visual resource map 302 of the resources 104 of the organization 102.

As a first variation of this third aspect, many types of information may be conveyed by the visual resource map 302 of the performance of the resources, such as performance metrics, changes, and trends. Responsive to receiving a selection of a selected resources 104, the visual resource map 302 may present a variety of information about the selected resource 104; e.g., a performance indicator pane may be inserted adjacent to the visual resource map 302 detailing the characteristics and performance of the selected resource 104, including relationships with other resources 104 of the organization 102. The performance relationships of the resources 104 may also be conveyed in various ways, e.g., by arranging the visual layout of the resources 104 according to a data path or a sequence of functionality and/or dependency; by selecting the proximity of a first resource 104 to a second resource 104 according to a degree of the performance relationship of the resources 104; and/or by clustering resources 104 that share a set of relationships;

As further examples of this first variation of this third aspect, the visual indicator 308 of the effect 304 of a first performance indicator 116 of a first resource 104 on a second performance indicator 116 of a second resource 104. For example, in the example visual resource maps 302 of FIG. 3, the visual indicators 308 depict the direction of the effect 304 (which, in some circumstances, may indicate a bidirectional effect); the magnitude of the effect 304, illustrated in this example scenario 300 as a shading of the visual indicator 308 to indicate that the performance of the first resource 104 significantly affects the performance of the second resource 104, and an absence of shading to indicate that the performances of the resources 104 are not significantly related by effect 304; and a sufficiency of the effect 304, illustrated in this example scenario 300 as an average size to indicate that the performance of the second resource 104 is acceptable (i.e., not unduly constrained) due to the performance of the first resource 104, and a small size to indicate that the performance of the second resource 104 is significantly constrained by the performance of the first resource 104.

As a still further example of this first variation of this third aspect, the consequences of the effect 304 may be presented in the visual resource map. As a first such example, an embodiment may determine whether the constraint is currently of significant concern. For example, a reduced performance of the second file server 206 may significantly constrain the performance of the second process server 202, but the second process server 202 may not currently be in use, or may be used in ways that are not significantly affected by reduced performance. Alternatively, if the reduced performance of the second process server 202 has a significant impact on current uses of the second process server 202, an alert 310 may be displayed on the visual resource map 302 to draw the attention of a user to the effect 304 and the constraint on the performance of the second process server 202. As a second such example, the magnitude of the effect may be measured and presented, e.g., as an increase in a wait time for completing a performance-dependent process. As a third such example, an embodiment may estimate a user count of users affected by the effect 304 of the first performance indicator 116 on the second resource 104, and indicate, on the visual resource map 302, the user count of users affected by the effect 304 of the first performance indicator 116 on the second resource 104.

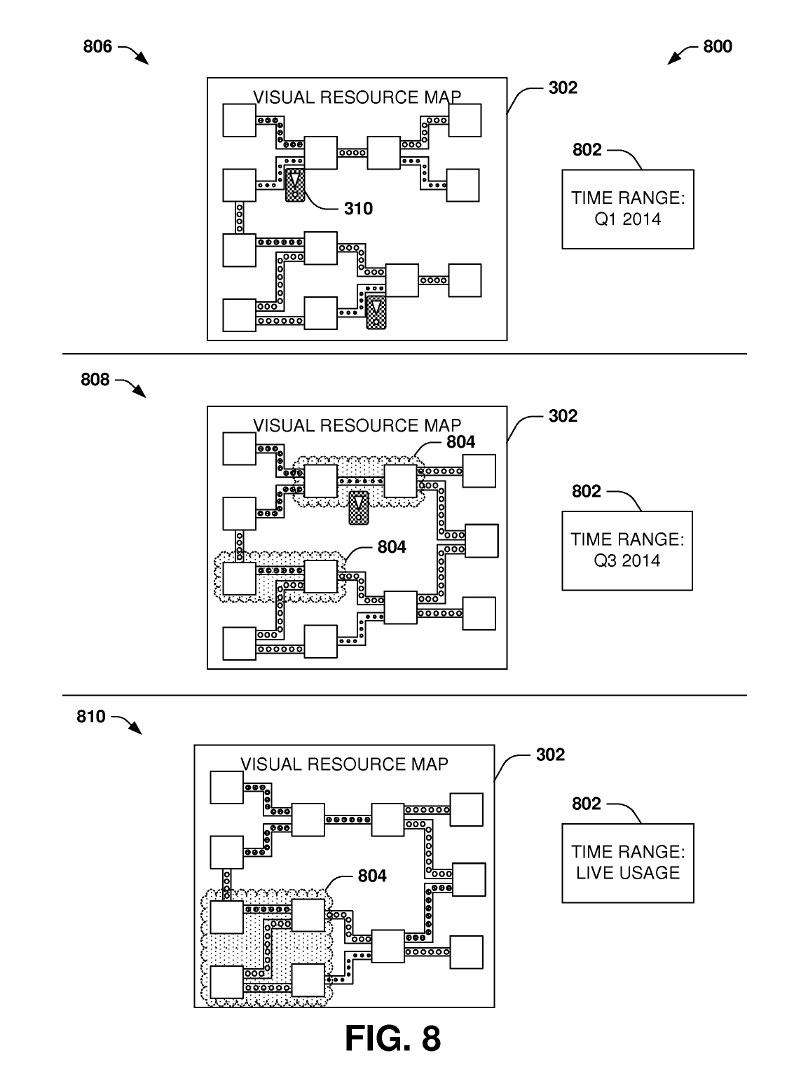

FIG. 8 presents an illustration of an example scenario 800 featuring various visual resource maps 302 that present a second set of variations of this third aspect. As a first such variation, in this example scenario 800, a first visual resource map 806 presents the resources 104 of the organization 102 at a first selected time, such as a first time range 802 selected by the user 416; and a second visual resource map 808 presents the resources 104 of the organization 102 at a second selected time, such as a second time range 802 selected by the user 416, to depict changes to the resources 104 of the organization 102 and the effects 304 on the performance thereof. A resource change indicator of changes to the resources 104 may also be included to depict the changes in the performance between the first selected time and a second selected time (e.g., an indicator that network bandwidth has increased by 20% between a first selected time and a second selected time).

As a second example of this second variation of this third aspect, the visual resource map 302 may also indicate the status and/or usage of various resources 104, such as a current load, volume, or available capacity of a resource 104. As one such example, the selected time for the visual resource map 302 may include a current time, which may indicate a live usage of the resources 104. The usage may be depicted, e.g., as a heat map 804 indicating the resource 104 that are currently experiencing high demand, usage, load, and/or performance (e.g., highlighting the resources 104 that are currently operating at or near maximum achievable performance, to distinguish such resources 104 from idle resources 104). As one such example, an embodiment may determine a resource usage trend that is indicated between a first selected time and a second selected time, and present, on the visual resource map 320, a resource trend indicator of the resource usage trend of the resource 104 between the first selected time and the second selected time (e.g., a 20% increase in the users' usage of a particular resource 104)

As a third example of this second variation of this third aspect, alerts may be displayed to draw the attention of the user 416 to significant performance issues. For example, for the resources 104 of the organization 102, an embodiment may compare a performance indicator 116 of the resource 104 with a performance indicator threshold, and responsive to determining that the performance indicator 116 of the resource 104 exceeds the performance indicator threshold, the visual resource map may include an alert 310 indicating that the performance indicator 116 of the first resource 104 exceeds the performance indicator threshold. Additionally, an embodiment may identify a performance adjustment of at least one resource 104 that alleviates the alert 310, and may propose the performance adjustment as a resource recommendation to the user 416.

As a fourth example of this second variation of this third aspect, the visual resource map 302 may assist the user in evaluating options for expanding the performance of the resources 104 of the organization 102. For example, responsive to receiving a proposed modification of a first resource 104, an embodiment may determine a performance adjustment 312 of the first performance indicator 116 of the first resource 104 in response to the proposed modification, and an effect 304 of the performance adjustment on the second performance indicator 116 of the second resource 104. The embodiment may then advise the user 416 of the performance adjustment and the effect 304 of the proposed modification. Many such variations may be included in the presentation of the visual resource map 302 and the uses of the effect 304 of the performance relationship of the first resource 104 and the second resource 104 in accordance with the techniques presented herein.

E4. Planning, Evaluating, and Recommending Adjustments of Resource Set

A fourth aspect that may vary among embodiments of the techniques presented herein involves the use of the visual resource map 302 to facilitate a user in planning and evaluating the adjustment of the resources 104 of the organization 102.

As a first variation of this fourth aspect, a user may wish to adjust the number, associations, and configuration of the resources 104 of the organization 102, and to understand the effects on the interrelationships of the resources 104. For example, a user may be interested in addressing a particular performance characteristic of the resources 104, such as load balancing, energy or network efficiency, and network throughput. Adjustments of the resources 104 may alter such characteristics in ways that may be difficult for the user to predict, such as the effects 304 of altering some resources 104 on other resources 104 of the organization 102 and the achievable performance. An interactive visual resource map 302 may be presented to the user that allows changes to the resources 104, and the performance relationships among such resources 104 may be evaluated and displayed to the user as an indication of the performance of the resource set.

As a second variation of this fourth aspect, a user may wish to evaluate the performance of the resources 104 of the organization 102 in particular circumstances, e.g., achievable network throughput for a particular configuration of resources 104 under specific types of network load. An embodiment of the techniques presented herein may be able to simulate the resources 104 of the organization 102 under such conditions, and to present a report of the performance of such resources 104 under the specified conditions. The simulation report may be presented to the user qualitatively (e.g., “network performance: good”) and/or quantitatively, and may be presented to the user in a reference-free manner (e.g., performance metrics) or relative to other configurations of the resources 104 of the organization 102.

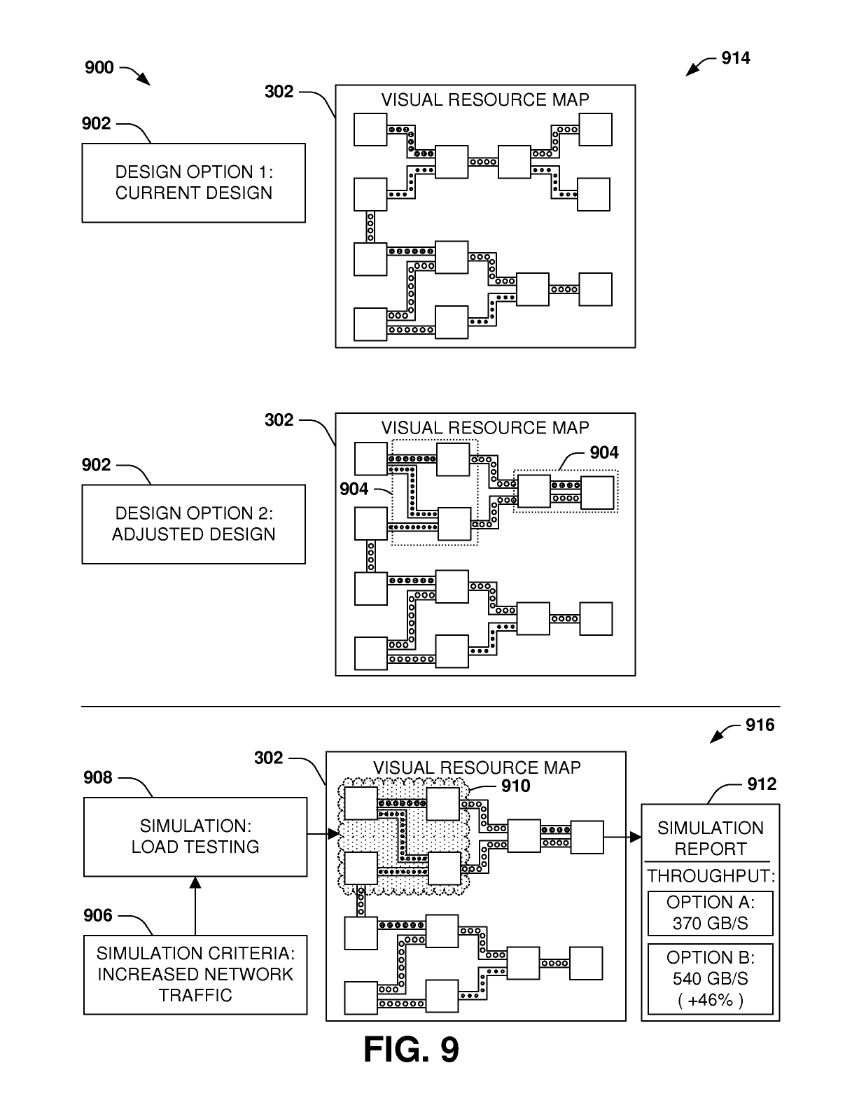

FIG. 9 presents an illustration of an example scenario 900 featuring a presentation of a visual resource map 302 of resources 104 in an interactive manner that assists a user in evaluating adjustments to the resources 104. In this example scenario 900, as a first such example 914, a first design 902 may be presented to the user as a visual map 302 of the current configuration of resources 104 of the organization 102, including visual indication of the interrelationships and performance indicators. The user may be permitted to adjust the resources 104 of the organization 102 to produce a second design 902 with some adjustments 904 in the configuration of the resources 104, such as adding resources 104; removing resources 104; and reorganizing and/or reconfiguring the resources 104. The visual indicators among the resources 104 may be updated to reflect the adjustments 904 of the second design 902. As a second such example 916, a user may wish to view a simulation 908 of the current and/or adjusted designs 902 of the resources 104, and may specify simulation criteria 906, such as the circumstances of the simulation 908. An embodiment may apply the simulation criteria 906 to a model of the resources 104 matching the selected design 902, may display the simulation criteria 906 on the visual resource map 302 (e.g., showing a location 910 where increased network traffic is likely to impact the resources 104 of the organization 102), and may present a simulation report 912 indicating the performance of the resources 104, either as reference-free metrics or with respect to another design 902, such as the current design of the resources 104. In this manner, the visual resource map 302 may assist the user with exploring adjustments 904 of designs 902 of the resources 104 and viewing the effects thereof.

As a third variation of this fourth aspect, an embodiment of the techniques presented herein may assist with the selection of adjustments 904 of various designs 902 of the resources 104, and/or the evaluation of such adjustments 904 beyond a simulation of the performance thereof. For example, a state search may be performed among the options for adjusting the current design 902, and an evaluation technique may be applied to various candidate designs 902 to estimate the effects thereof. In addition to performance, such effects may include, e.g., administrative complexity; dependency upon human resources to reconfigure, manage and utilize the resources 104; cost; and logistics. Such evaluation may be performed, e.g., at the request of the user, as a periodic reevaluation of the resources 104, or upon detecting a change or option for change among the resources 104 or performance thereof. If an adjustment 904 of a current design 902 is identified that presents a significant benefit, the evaluation may be presented to the user as a recommendation of such change.

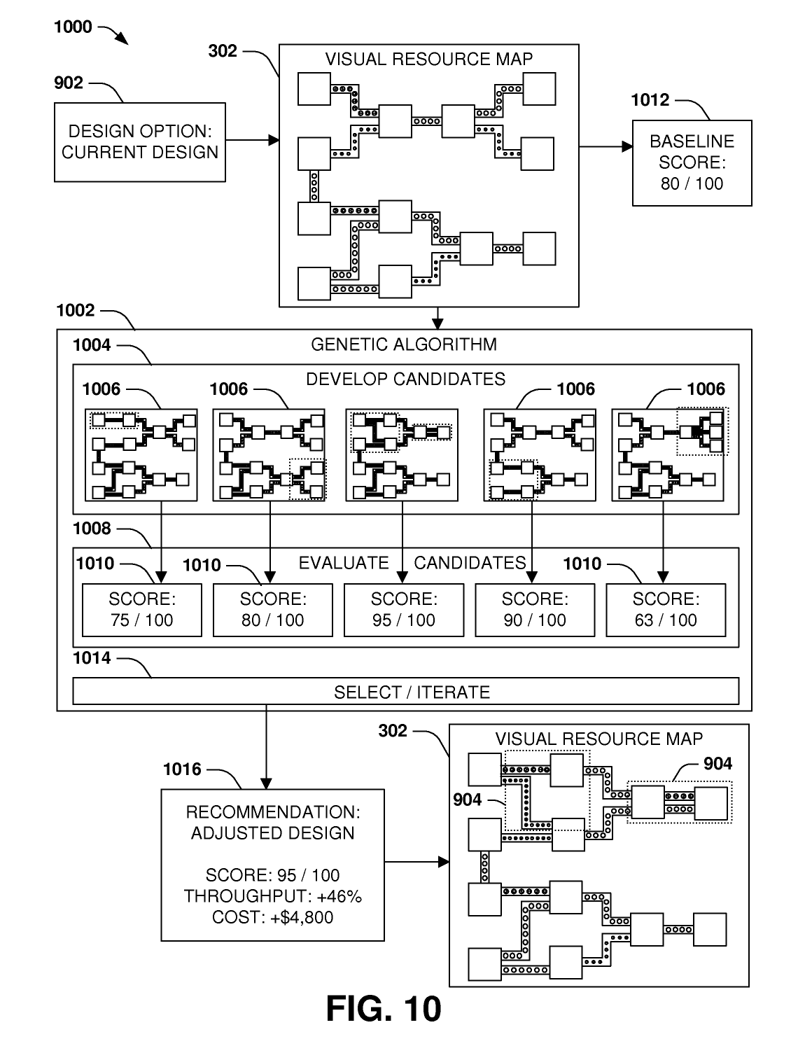

FIG. 10 presents an illustration of an example scenario 1000 featuring an example technique for automatically evaluating the resources 104 of an organization 102. In this example scenario 1000, a genetic algorithm 1002 is applied to a current design 902 to identify recommendations 1016 for adjustments 904 of the current design 902 of the resources 104. The genetic algorithm 1002 involves a development 1004 of candidates 1006, e.g., as incremental changes to a current design 902, implemented randomly and/or based upon heuristics. The various candidates 1006 may then be evaluated 1008 through various criteria, such as performance, efficiency, and cost, and a score 1010 may be identified. The highest-scoring candidates 1008 may be selected 1014 for another iteration (e.g., a second round of candidates 1006 may be adapted and evaluated based on the highest-scoring candidates 1008 in the first round), until the state search is completed and/or a score gain threshold is met (e.g., identifying candidates with at least 10% higher scores than a baseline score 1012 of the current design 902). A recommendation 1016 may then be presented to the user that describes the highest-scoring candidates 1006 and the advantages thereof, e.g., gains in the performance, efficiency, cost, or other factors of the resources 104 of the organization 102. Many such techniques may be utilized to assist a user in planning, evaluating, and recommending adjustments 904 of the designs 902 of the resources 104 of the organization 102 in accordance with the techniques presented herein.

### F. Computing Environment

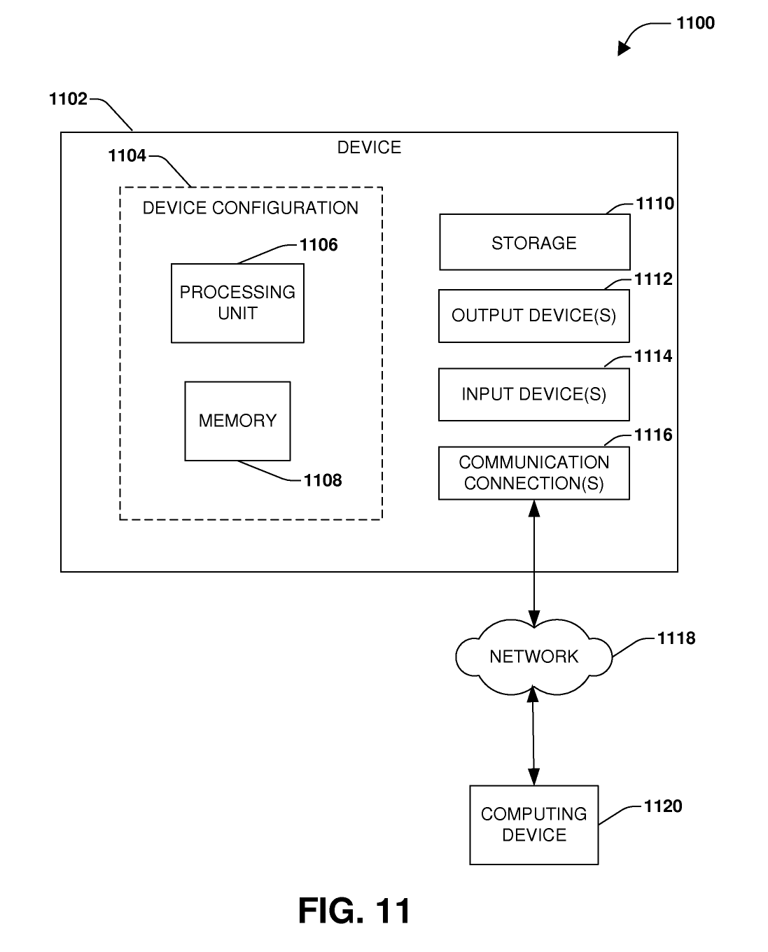

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1102 configured to implement one or more embodiments provided herein. In one configuration, computing device 1102 includes at least one processing unit 1106 and memory 1108. Depending on the exact configuration and type of computing device, memory 1108 may be volatile (such as RAM, for example), non-volatile (such as ROM, flash memory, etc., for example) or some combination of the two. This configuration is illustrated in FIG. 11 by dashed line 1104.

In other embodiments, device 1102 may include additional features and/or functionality. For example, device 1102 may also include additional storage (e.g., removable and/or non-removable) including, but not limited to, magnetic storage, optical storage, and the like. Such additional storage is illustrated in FIG. 11 by storage 1110. In one embodiment, computer readable instructions to implement one or more embodiments provided herein may be in storage 1110. Storage 1110 may also store other computer readable instructions to implement an operating system, an application program, and the like. Computer readable instructions may be loaded in memory 1108 for execution by processing unit 1106, for example.

The term “computer readable media” as used herein includes computer-readable memory devices that exclude other forms of computer-readable media comprising communications media, such as signals. Such computer-readable memory devices may be volatile and/or nonvolatile, removable and/or non-removable, and may involve various types of physical devices storing computer readable instructions or other data. Memory 1108 and storage 1110 are examples of computer storage media. Computer-storage storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 1102 may also include communication connection(s) 1116 that allows device 1102 to communicate with other devices. Communication connection(s) 1116 may include, but is not limited to, a modem, a Network Interface Card (NIC), an integrated network interface, a radio frequency transmitter/receiver, an infrared port, a USB connection, or other interfaces for connecting computing device 1102 to other computing devices. Communication connection(s) 1116 may include a wired connection or a wireless connection. Communication connection(s) 1116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1102 may include input device(s) 1114 such as keyboard, mouse, pen, voice input device, touch input device, infrared cameras, video input devices, and/or any other input device. Output device(s) 1112 such as one or more displays, speakers, printers, and/or any other output device may also be included in device 1102. Input device(s) 1114 and output device(s) 1112 may be connected to device 1102 via a wired connection, wireless connection, or any combination thereof. In one embodiment, an input device or an output device from another computing device may be used as input device(s) 1114 or output device(s) 1112 for computing device 1102.

Components of computing device 1102 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1102 may be interconnected by a network. For example, memory 1108 may be comprised of multiple physical memory units located in different physical locations interconnected by a network.

Those skilled in the art will realize that storage devices utilized to store computer readable instructions may be distributed across a network. For example, a computing device 1120 accessible via network 1118 may store computer readable instructions to implement one or more embodiments provided herein. Computing device 1102 may access computing device 1120 and download a part or all of the computer readable instructions for execution. Alternatively, computing device 1102 may download pieces of the computer readable instructions, as needed, or some instructions may be executed at computing device 1102 and some at computing device 1120.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system for presenting resources of an organization to a user, the system comprising:
a device;
a display; and
a memory storing instructions that, when executed by the processor, provide a system comprising:
a performance evaluator that:
identifies a first performance indicator of a first resource of the organization, and a second performance indicator of a second resource of the organization; and
determines an effect of the first performance indicator of the first resource on the second performance indictor of the second resource; and
a visual resource map presenter that presents to the user, on the display, a visual resource map of the resources of the organization that includes a visual indicator of the effect of the first performance indicator of the first resource on the second performance indicator of the second resource.

2. The system of claim 1, wherein the performance evaluator further selects the second resource by determining that a result produced by the first resource is consumed by the second resource.

3. The system of claim 1, wherein the performance evaluator further selects the second resource by determining that the first resource and the second resource share a limited capacity of a third resource.

4. The system of claim 1, wherein:
the first resource and the second resource are respectively of a resource type selected from a resource type set, comprising:
a data resource that produces data,
a content resource that provides content,
a computational resource that performs computation,
a storage resource that stores data, and
a network resource that provides connectivity;
the memory further stores, for respective resources types of the resource type set, a performance template that is applicable to resources of the resource type to present performance indicators for the resource; and
the performance evaluator further identifies the performance indicators for respective resources by:
retrieving a selected performance template according to the resource type of the resource; and
applying the selected performance template to the resource.

5. The system of claim 1, wherein the performance evaluator further identifies performance indicators of the first resource and the second resource by, for the respective resources:
initiating a load test of the resource; and
during the load test, measuring the performance indicator of the resource.

6. The system of claim 1, wherein the performance evaluator further identifies performance indicators of the first resource and the second resource by, for the respective resources:
identifying a model performance indicator of the resource in unconstrained conditions;
determining a constraint of the resource during operation of the organization; and
adjust the model performance indicator of the resource according to the constraint.

7. The system of claim 1, wherein the performance evaluator further identifies performance indicators of the first resource and the second resource by, for the respective resources:
during operation of the resource of the organization, record an observed performance indicator of the resource; and
identify the performance indicator of the resource according to the observed performance indicator.

8. The system of claim 7, wherein recording the observed performance indicator of the resource during operation of the organization further comprises:
determining a condition of the operation of the resource of the organization, wherein the condition affects the first performance indicator;
recording the observed performance indicator and the condition of the operation; and
develop a performance indicator model of the resource over a range of the condition.

9. A method of presenting resources of an organization to a user of a device having a processor and a display, the method comprising:
executing, on the processor, instructions that cause the device to:
identify a first performance indicator of a first resource of the organization, and a second performance indicator of a second resource of the organization;
determine an effect of the first performance indicator of the first resource on the second performance indictor of the second resource; and
present to the user, on the display, a visual resource map of the resources of the organization that includes a visual indicator of the effect of the first performance indicator of the first resource on the second performance indicator of the second resource.

10. The method of claim 9, wherein determining the effect of the first performance indicator of the first resource on the second performance indicator of the second resource further comprises:
determining an initial observation of the second performance indicator;
while applying an adjustment to the first performance indicator, determining an adjusted observation of the second performance indicator that is responsive to the adjustment; and
comparing the initial observation to the adjusted observation of the second performance indicator to determine the effect of the adjustment of the first performance indicator.

11. The method of claim 10, wherein:
determining adjusted observations responsive to a set of adjustments of the first performance indicator; and
developing an effect model of adjustments of the first performance indicator on the second performance indicator.

12. The method of claim 9, wherein:
executing the instructions further causes the device to record the first performance indicator and the second performance indicator over a time range; and
determining the effect of the first resource indicator on the second resource indicator further comprises: correlating respective adjustments of the first performance indicator of the first resource with an effect of the second performance indicator of the second resource.

13. The method of claim 9, wherein:
determining the effect of the first performance indicator on the second performance indicator further comprises: estimating a user count of users affected by the effect of the first performance indicator on the second resource; and
presenting the visual resource map further comprises: indicating, on the visual resource map, the user count of users affected by the effect of the first performance indicator on the second resource.

14. The method of claim 9, wherein executing the instructions on the processor further causes the device to:
for respective resources of the organization, compare a performance indicator of the resource with a performance indicator threshold; and
responsive to determining that the performance indicator of the resource exceeds the performance indicator threshold, present, on the visual resource map, an alert that indicates that the performance indicator of the first resource exceeds the performance indicator threshold.

15. The method of claim 14, wherein executing the instructions on the processor further causes the device to:
identify a performance adjustment of at least one resource of the organization that alleviates the alert; and
propose the performance adjustment as a resource recommendation to the user.

16. The method of claim 9, wherein executing the instructions on the processor further causes the device to, responsive to receiving a proposed modification of the first resource:
determine a performance adjustment of the first performance indicator in response to the proposed modification;
determine an effect of the performance adjustment on the second performance indicator of the second resource; and
advise the user of the performance adjustment and the effect of the proposed modification.

17. A method of enabling a user to examine resources of an organization on a device having a processor and a display, the method comprising:
executing, on the processor, instructions that cause the device to, responsive to a selection by the user of a performance adjustment of a first resource of the organization:
determine an effect of the performance adjustment of the first resource on a second performance indictor of a second resource of the organization; and
present to the user, on the display, a visual resource map of the resources of the organization, including a visual indicator of the effect of the adjustment of the first performance indicator of the first resource on the second performance indicator of the second resource.

18. The method of claim 17, wherein presenting the visual resource map further comprises: presenting, on the visual resource map, a heat map that visually indicates at least one of the first performance indicator and the second performance indicator.

19. The method of claim 17, wherein presenting the visual resource map further comprises: presenting, on the visual resource map:
the resources of the organization at a first selected time; and
a resource change indicator of changes to the resources between the first selected time and a second selected time.

20. The method of claim 17, wherein:
executing the instructions causes the processor to determine a resource usage trend that is indicated between a first selected time and a second selected time; and
presenting the visual resource map further comprises: presenting, on the visual resource map, a resource trend indicator of the resource usage trend of the resource between the first selected time and the second selected time.
